(19) United States
(12) Patent Application Publication
(10) Pub. No.: US 2014/0351138 A1
(43) Pub. Date: Nov. 27, 2014

(54) Payment System for Vehicle Fueling

(71) Applicant: P97 Networks, Inc., Houston, TX (US)

(72) Inventors: Donald J. Frieden, Friendswood, TX (US); Michael W. Coming, Double Oak, TX (US)

(73) Assignee: P97 Networks, Inc., Houston, TX (US)

(21) Appl. No.: 14/358,276

(22) PCT Filed: Nov. 16, 2012
(86) PCT No.: PCT/US12/65632

§ 371 Date: May 15, 2014

Related U.S. Application Data
(60) Provisional application No. 61/560,510, filed on Nov. 16, 2011.

(51) Int. Cl. G06Q 20/40; G06Q 20/20; G06Q 50/06; G06Q 20/32

(52) U.S. Cl. CPC G06Q 20/4014; G06Q 20/322; G06Q 20/20; G06Q 50/06
USPC 705/44

(57) ABSTRACT

A secure wireless vehicle fueling payment system which provides a multi-factor authorization and identity scheme while encouraging vehicle occupants to remain in the vehicle while using a mobile device to initiate the payment transaction utilizing an mobile commerce site server to integrate with existing POS systems, fuel control networks, and fueling dispensers.

### CROSS-REFERENCE TO RELATED APPLICATION

This application claims priority from U.S. Provisional Application No. 61/560,510 filed on Nov. 16, 2011, the disclosure of which is incorporated herein by reference for all purposes.

### FIELD OF THE INVENTION

The present invention is in the technical field of an automated Point of Sale (“POS”) payment system for vehicle fueling operations directed to provide a safe and convenient system for electronic payment. More particularly, the present invention involves a wireless electronic payment system, using a mobile device such as a smartphone or other mobile device which provides a multi-factor authentication with attention to securing the consumer's primary account data and providing a safer payment option for motor vehicle operators.

### BACKGROUND OF THE INVENTION

Large scale use of POS systems and electronic payments systems has profoundly changed the way consumers pay for goods and services. Most retailers, including gas stations, utilize POS systems and integrated payment networks to process credit and debit card transactions. It is not surprising that attention has been directed to various systems for speeding up and facilitating electronic commerce, including replacing credit cards with smartphones as electronic wallets. In this case, software turns smartphones into “e-wallets,” so consumers can purchase goods and services at special POS terminals with the swipe of their mobile device, therefore eliminating the need for plastic credit cards and debit cards.

Certain retailers are beginning to facilitate e-wallets transactions based on near-field communications (“NFC”) technology. Unlike many other wireless technologies, NFC has a short range of about 1.5 inches which requires close proximity to a check-out terminal. This makes it a good choice for secure transactions, such as contactless credit card payments.

However, NFC technology will not work for e-wallet transactions with vehicle fueling payments because the customer would be required to physically emerge from the vehicle and swipe their mobile device at the gas pump, which is not an acceptable practice because cell phones should not be used within close proximity of fueling operations for safety reasons. Additionally, in view of the extreme complexity of integrated POS hardware in fuel dispensing systems replacing the current POS hardware would require years and is very costly, while potentially frustrating consumers that are not ready to give up their plastic credit cards.

Accordingly, there is a need for an e-wallet system that is integrated with fueling control and POS systems that combines the convenience of automated systems with the safety and versatility required for fuel transfer operations.

Further, there is a need for automated vehicle fueling payment systems which allows vehicle occupants to initiate a fuel payment transaction using an electronic device, such as a mobile device, prior to exiting the vehicle, because the presence of an electronic device during a fueling operation could to be hazardous and fire codes prohibit cell phone use near pumps.

The disadvantages of the prior art are overcome by the present invention, an improved payment system for vehicle fueling is hereinafter disclosed.

### SUMMARY OF THE INVENTION

The present invention is a payment system for vehicle fueling which supports wireless e-wallet payments initiated by a mobile device while co-existing with existing POS systems. More particularly, the present invention involves a secure payment system which requires a multi-stage authorization while encouraging vehicle occupants to remain in the vehicle while using a mobile device to initiate the payment transaction.

These and further features and advantages of the present invention will become apparent from the following detailed description, wherein reference is made to the figures in the accompanying drawings.

### BRIEF DESCRIPTION OF THE DRAWINGS

The accompanying drawings are included to provide a further understanding of the invention and are incorporated in and constitute a part of this specification, illustrate several embodiments of the invention and together with the description serve to explain the principles of the invention.

FIG. 1 is a schematic block diagram illustrating a side view of a service station equipped in accordance with the present invention;

FIG. 2 is a schematic block diagrams illustrating components of a vehicle fueling system integrated with a wireless network, POS system and host computer used in the service station of FIG. 1;

FIG. 3 is a front view of a payment terminal for a fuel dispensing system and keypad;

FIG. 4 is a flowchart depicting a method for initiating a fuel purchase workflow with a mobile device in accordance with one embodiment;

FIG. 5 is a flowchart depicting a method for using a network protocol and network session to verify an installation ID request and confirmation in accordance with one embodiment; and

FIG. 6 is flowchart depicting a method for depicting an identity based communication link between a mobile device and a web server in accordance with one embodiment.

### DETAILED DESCRIPTION OF PREFERRED EMBODIMENTS

In accordance with the invention, a wireless enabled mobile device using a multi-factor authentication method to create a secure payment system and method for integrating with existing POS and fuel dispensing control systems which allows the occupant of a vehicle to conveniently initiate an electronic payment while remaining in the vehicle. The invention comprises identification data and responses to enable a secure session between the POS system and a customer's mobile device. The mobile device generates a first signal to create a connection between the mobile device and a mobile commerce web server, hereinafter called “web server”, including the software applications running on cloud based web servers which incorporate a web server, application server, database server, and server management tools which provide scalability, redundancy, and clustering. In order to create a secure communication session, the customer's mobile device must have software, provided by the invention, installed on the device. The web server generates a response signal in order to initiate the session between the mobile device and the web server.

The term “mobile device” as used herein means any portable device capable of communicating with POS system, including cell phones, mobile phones, smart phones, smart pads, personal data assistants, tablet devices, or other portable computing devices.

Once the mobile device has established a session with the web server, a vehicle occupant (the customer), can initiate the purchase of fuel from within their vehicle. The use of the mobile device and the initiation of a fuel purchase is entirely controlled from within the vehicle. Included within the series of communications between the mobile device and web server is an acknowledgement of the hazards associated with using a mobile device after exiting the vehicle.

Reference will now be made in detail to the present preferred embodiments of the invention, examples of which are illustrated in the accompanying drawings.

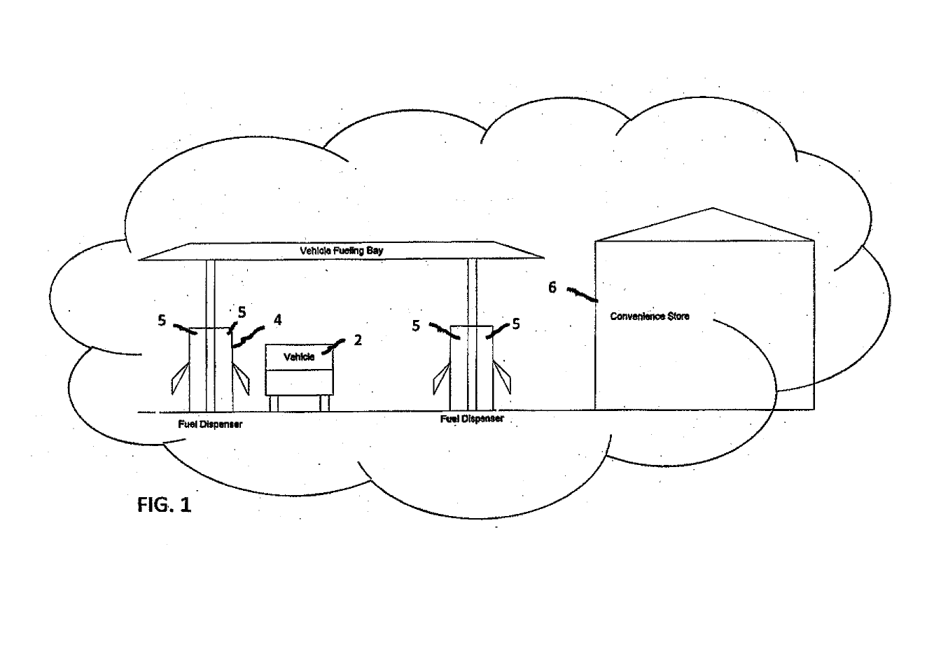

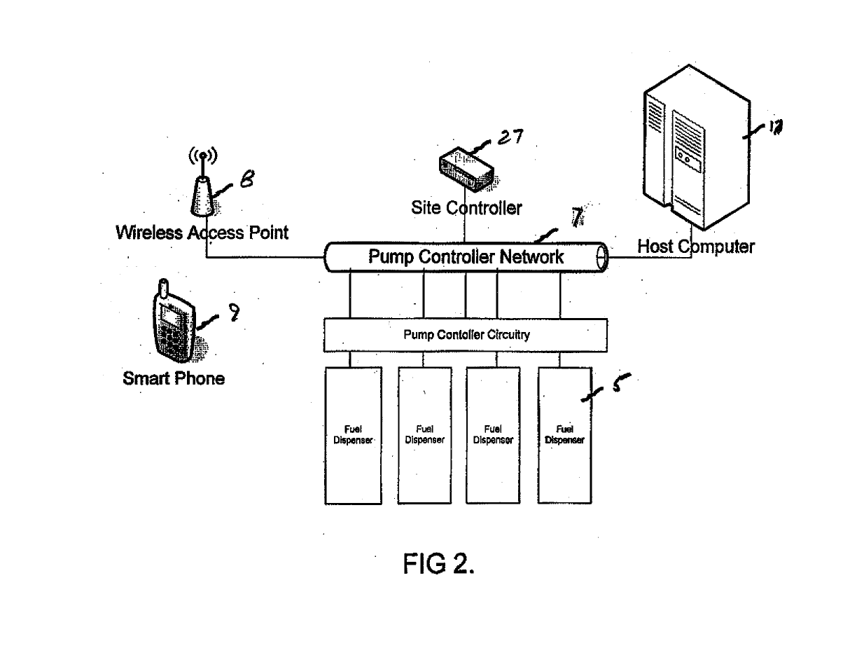

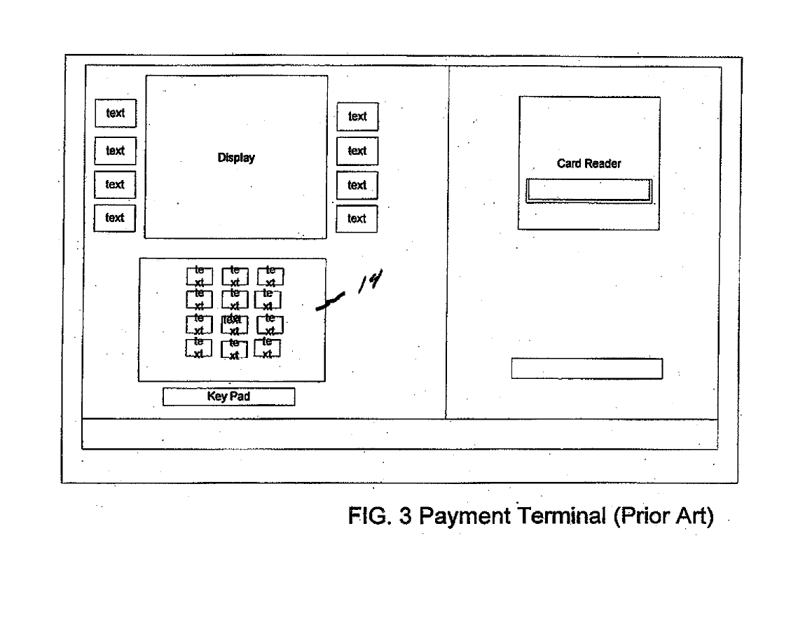

In FIG. 1, reference numeral 2 refers to a vehicle, occupant, and mobile device embodying features of the present invention. The mobile device communicates with the web server and identifies a fueling station when the vehicle is within a predetermined distance of the station, reference numeral 3, and the web server sends a response to the mobile device in the vehicle. The mobile device application prompts the vehicle operator to acknowledge the intent to make a fuel purchase, thereby requesting an authorization from the payment network, reference numeral 5, to initiate the transaction involving the purchase of fuel by a customer within the vehicle 2, and subsequently authorizes the POS system and pump control network to activate the keypad on the fuel dispenser 4 (also noted in FIG. 3) for the customer to enter a Passcode. Once the customer enters the correct Passcode on the keypad, the second step of the multi-factor authentication is complete. The system (noted in FIG. 2) then allows customers to pump fuel from the fuel dispenser that was authorized during the multi-factor authentication process. Upon completion of the fueling operation the charges will be settled on the proper account by the POS system (FIG. 2) and an optional electronic receipt will be provided to the consumer.

In one embodiment (FIG. 1), the system (FIG. 2) is implemented in a service station environment that includes any number of fuel dispensers 5, it being understood that the number of islands and pumps, as well as their geometry and relationship to one another, may vary according to the requirements of the environment. Communication and synchronization lines, discussed more fully below, connect the dispensers 5 to a fuel control network 7 for controlling operation of the dispensers. An additional site 6, representing a convenience store is also connected to the fuel control network 7. It is also understood that the computer 17 may be connected to a network (not shown) for performing functions including, but not limited to, customer billing verification.

Wireless Customer Identification Processing and Pump Controller Network

In FIG. 2, reference numeral 8 refers to a wireless access point, or cellular network tower, which enables communication with a mobile device 9. The wireless access point, or cellular network tower 8 for detecting and communicating with the customer's mobile device in the vehicle 2 enables a communication channel to the web server. Upon connection, the software application on the mobile device, communicates with the web server 10, so the customer mobile device identification data is sent to the mobile commerce site server 27, referred to as “site server” hereafter. On initial network connection with the web server, the software application on the mobile device will look for an application installation identification file. If the identification file does not exist, the software application on the mobile device will generate a log-in form requesting an identification number from the identification and processing server. Once a mobile device has a proper identification number, which will uniquely identify that instance of the mobile device application, the mobile device will be registered and authenticated on the network, as well as each future connection of that mobile device to the network.

FIG. 2 graphically illustrates the operation of the pump controller network 7 with integration between the fuel dispensers 5, web server 10, and site server 27. Information about the pump control network is publicly available from prior art.

Referring again to FIG. 1, it is understood the illustration is not necessarily drawn to scale. Each fuel dispenser 5 can have two or more separate dispensing areas and each dispensing area has its own payment terminal, denoted in FIG. 3, with key pad data entry device 14. As indicated, each dispensing area typically also has a key pad data entry device 14, that a customer will use to enter a Passcode to provide the final multi-factor authorization required to complete the purchase initiated with the mobile device from within the vehicle. Further, the customer can make other selections, at the payment terminal in FIG. 3, such as adding a car wash after fueling (if applicable) and where messages may be displayed to the customer.

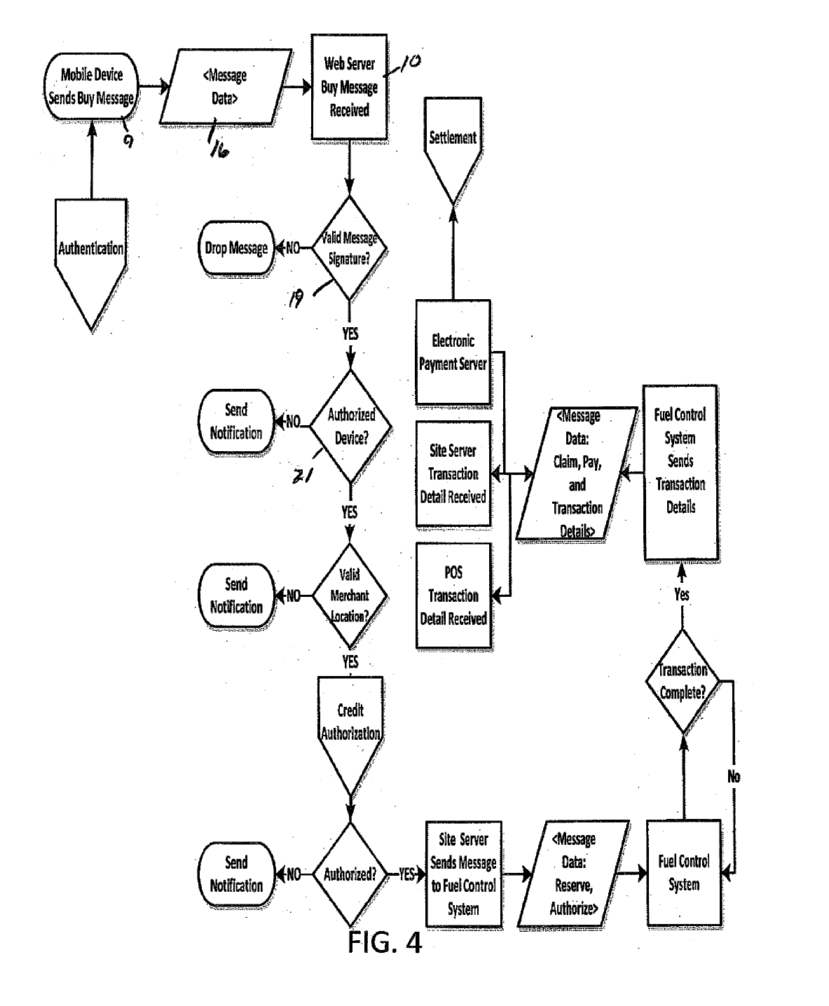

FIG. 4 illustrates a workflow using a mobile device to securely authenticate and establish the identity of a consumer with a network to initiate and transact a fuel purchase. The workflow may be performed using a mobile device, at any number of fueling locations and integrated with many different types of fuel control systems, fuel dispensers, and POS systems to purchase fuel. Further, the workflow includes instructions for performing each action in the action sequence in a specific order, and the instructions may include a set of instructions for the mobile device, for a web server, a site server, and instructions for a fuel control system, wherein the fuel control system may provide additional instructions through a network interface. For example, the fuel control system may send fuel purchase transaction details for reconciliation to the POS system, site server, and electronic payment server. As show in FIG. 4, using a menu on a mobile device 9, a consumer enters a passcode to authenticate themselves with the mobile device. Once the user is authenticated on the mobile device, a “buy gas” icon on the display of the mobile device 9 may be selected, and an application associated with that icon sends message data 16, which includes a plurality of action sequences to be stored and executed by and between the mobile device 9 and the web server 10. Once the web server receives some action sequences from the mobile device, the web server executes a plurality of action sequences, including validating the device signature 19, confirms the device is authorized 21, and then the application on the mobile device provides a list of options including a search feature for merchant locations based on geo-coordinates, current prices for fuel, driving directions to a merchant location, and workflow steps to enable the purchase fuel from the mobile device once a user has arrived at a merchant location. If any of the plurality of action sequences is determined invalid during a task execution, then specific actions including messages and notifications are sent back to the mobile device. For example, if the mobile device signature is not valid, the web server will drop the message 20 in order to terminate the session and secure against fraudulent users or transactions.

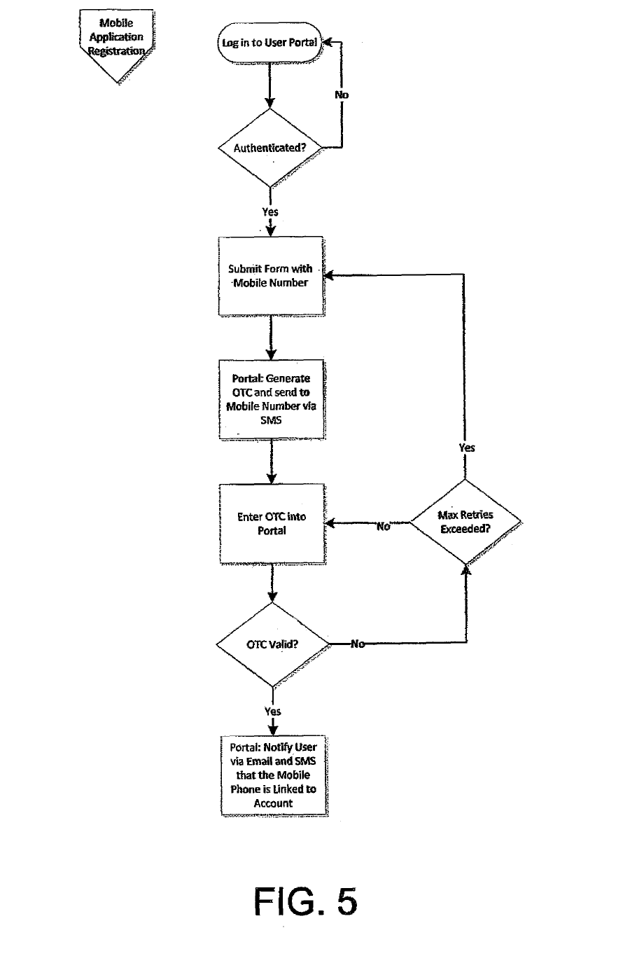

Additional details of the plurality of action sequences related to the mobile device signature validation may be better understood through reference to FIG. 5, which is a block diagram illustrating the initial device registration workflow and various features of the security protocol, within an identity based communication link between a mobile device and a web server in accordance with one embodiment of the present invention. The workflow in FIG. 5 includes the steps to log into the application on the mobile device and establish a secure connection between the mobile device 9 and the web server 10. An application installation ID file on the mobile device 9 and corresponding ID file on a cloud based web server establish a trust relationship to provide the secure connection between the mobile device and the web server. For example, during the “buy gas” application initialization, if the mobile device application determines the device does not have a valid application installation ID when executing an application initialization sequence, then a separate stored procedure with be executed by the mobile device 9 to start the workflow procedure to register the device. Accordingly, a procedure stored in the application on the mobile device will initialize a step which provides an input screen and form for a user to enter identification information such as a user name, address, phone number and passcode. Once the user has completed the form, a separate workflow step from the list of store procedures will cause the device to be authenticated, and a secure session is established between the mobile device and the web server 10. Based on received properties from the mobile device, the web server will check the registration status of the mobile device and generate and issue a unique application ID to an application on the mobile device. To further secure the identity and trusted status of the mobile device, each unique application installation ID number can only be issued one time and each software installation can only have one application installation ID.

As FIG. 5 further illustrates, the invention provides a method for connecting and integrating a user database hosted on the web server to manage users and corresponding relationships with mobile devices, including a definition file with information about the storage location of the application installation ID for the mobile device. Therefore, each time a mobile device tries to register with the web server one of the plurality of workflow steps includes the verification of the application installation ID using a web server, a web service interface between the mobile device and a web server, and a secure communication protocol.

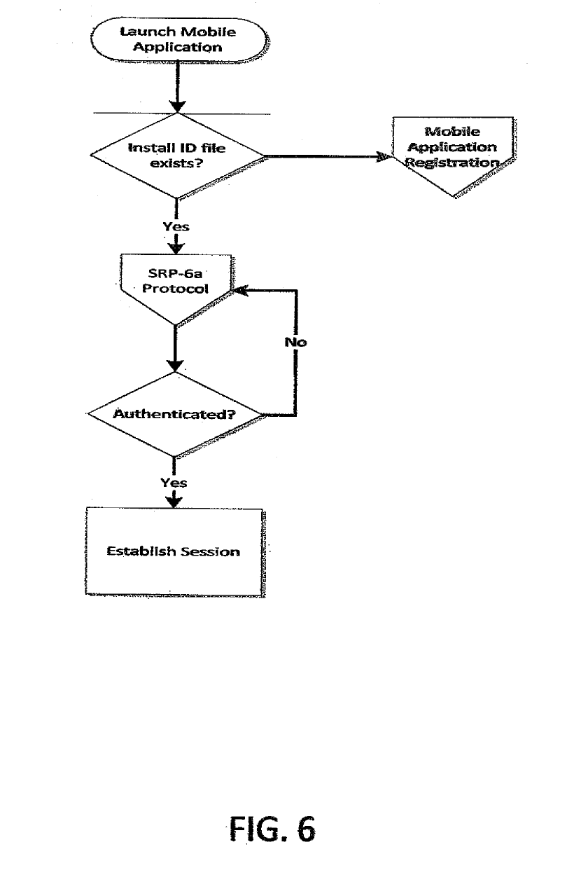

As the workflow steps in FIG. 6 illustrates, prevent unauthorized use of a mobile device or application installation ID, the invention uses a second and separate secure connection method to send the application installation ID to a mobile device and complete a registration link between the mobile device and the web server.

The advantages of the present invention included, without limitation, is an automated vehicle fueling payment system which does not require the vehicle occupants to actually emerge from the vehicle while using an electronic device, such as a mobile device, because the presence of an electronic device during a fueling operation could to be hazardous and fire codes prohibit the use of a cell phone, smart phone, or other mobile device usage near fuel dispensers. Further, attention has been directed to various systems for speeding up and facilitating electronic commerce, including replacing credit cards with cell phones as electronic wallets. While credit cards have historically provided a simple means of payment at fuel dispensers, they have only provided a limited amount of security for customer data. Effectively, credit card mag stripes and credit card chips (currently being promoted as more secure than mag stripe cards), only use a primary account number to validate a user. In some instances, the merchants payment network will ask for zip code as a second factor verification, however if the card is stolen, in most cases the card holder's zip code is easily discoverable. In the present invention, software on the mobile device incorporates features and integrations with payment networks so consumers can purchase vehicle fuel with their mobile device, therefore eliminated the need for plastic credit cards and debit cards. Further, the present invention, as previously noted in this section, provides a multi-factor authentication and identity scheme which enables an extremely secure payment transaction, which should advance and encourage the use of mobile payments at fueling locations.

The present invention includes an integration to most payment systems for supported by the oil company networks for vehicle fueling, including support for most of the loyalty card programs in the industry. Therefore, the e-wallet feature available on most mobile devices will be automatically integrated with a mobile device application in the present invention, which will provide support for discounts provided by the existing loyalty programs and POS systems.

While the foregoing written description of the invention enable one of ordinary skill to make and use what is considered presently to be the best mode thereof, those of ordinary skill will understand and appreciate the existence of variations, combination, and equivalents of the specific embodiment, method, and example herein, The invention should therefore not be limited by the above described embodiment, method, and examples, but by all embodiments and methods within the scope and spirit of the invention as claimed.

What is claimed is:

1. A method for determining a sequence of actions required to establish an identity based user authentication and secure communication link between a mobile device and a web server to effect a mobile commerce transaction, the method comprising:
displaying on the mobile device a log-on screen that presents a plurality of stored action sequences to be executed by an application on the mobile device, and wherein at least one of the plurality of stored action sequences looks for an application installation ID file;
determining a set of instructions based on properties received from the application on the mobile device, wherein the set of instructions enable another application on the web server to execute another set of instructions based on the properties received from the application on the mobile device, comprising:
based on a registration status of the mobile device, executing a workflow script based on the properties received from the application on the mobile device to enable the another application on the web server to generate an application installation ID for the mobile device, wherein an application installation ID file is not on the mobile device;
receiving user input from the application on the mobile device, including user identification and password; and
compiling two or more actions into an action sequence based on user input;
receiving data from the web server including a unique application ID file issued to the mobile device, wherein the application installation ID file is only valid for a single instance of the software application on the mobile device.

2. The method of claim 1, wherein determining a set of instructions comprises accessing information unique to an identity of the mobile device during initial registration with the web server and retrieval using one or more profile data files stored on the mobile device.

3. The method of claim 1, wherein at least one of the plurality of action sequences comprises an action sequence for connecting to a user database, and wherein the action sequence for connecting to the user database comprises actions including validating the application installation ID, receiving user credentials, and requesting a connection to the user database.

4. The method of claim 1, further comprising:
storing the application installation ID file received from the web server in a storage location of the mobile device, wherein the application file is determined by the mobile device using the set of instructions.

5. The method of claim 1, wherein at least one of the action sequences comprises a plurality of actions between the mobile device and the web server to establish a secure connection and relationship between the mobile device and the web server to identify the mobile device in future connections with the web server.

6. The method of claim 1, wherein received properties comprises requesting the properties from the web server, and wherein requested properties are determined based on the mobile device.

7. The method of claim 1, wherein the received properties specify a web service interface between the mobile device and a web server, and wherein the interface is using a secure communication protocol.

8. The method of claim 7, further comprising:
initiating a user verification sequence on the mobile device in response to the mobile device receiving an application installation ID file from the web server, wherein the application installation ID file is associated with the registration sequence and uses a separate channel and secure communication protocol to send a one-time code to a primary phone number of the mobile device to further secure the delivery of the application installation ID to the mobile device.

9. The method of claim 1, wherein displaying on the mobile device a confirmation screen comprises displaying a message screen in response to a registration link between the mobile device and the web server.

10. A method of creating an action sequence for fuel purchase request from a mobile device, the method comprising:
displaying a graphical user interface presenting a plurality of user selectable actions on the mobile device, each of the user selectable actions having corresponding instructions stored in the mobile device;
receiving a user input selecting two or more actions from the plurality of user selectable actions, wherein at least one of the selected two or more actions employs data, received from a web server, in an application stored on the mobile device to complete at least one action on the mobile device;
compiling selected two or more actions into an action sequence based on the user input;
generating a workflow script for the action sequence based on instructions;
receiving properties from the web server that describes merchant master data from the web server for performing the selected two or more actions of the action sequence, wherein the merchant master data includes data about retail fuel locations;
customizing the workflow script based on properties of the merchant master data to enable the web server to generate data for an application stored on the mobile device; and
customizing the workflow script based on the properties of the mobile device to display one or more actions of the action sequence that are supported by the mobile device application.

11. The method of claim 10, wherein the sequence comprises a plurality of actions and wherein determining instructions comprises:
displaying on the mobile device an input screen that identifies a list of available fueling locations;
receiving a user input selecting at least one of the fueling locations; and
customizing the workflow script for the selected fueling location.

12. The method of claim 10, wherein receiving a user input comprises displaying a screen of the user interface to facilitate user identification and execution for the selected two or more actions, and wherein the workflow script enables the mobile device to perform the selected action sequence, wherein an application installation ID file on the mobile device is verified to be authentic by a web server.

13. A method of creating an action sequence for a multi-factor fuel purchase authorization initiated from a mobile device to an on-site fuel controller, the method comprising:
displaying a graphical user interface presenting a plurality of user selectable actions on the mobile device, each of the selectable actions having corresponding instructions stored in the mobile device;
receiving a user input selecting two or more actions from the plurality of user selectable actions, wherein at least one of the selected two or more actions employs data, received from a mobile device, in an application stored on a web server;
displaying a graphical user interface on a fuel dispenser, presenting a plurality of instructions and user selectable actions on the a key pad on the fuel dispenser, each of the user selectable actions having corresponding instructions stored in an on-site fuel controller, wherein the on-site fuel controller is integrated with the fuel dispenser;
receiving user input from the key pad on the fuel dispenser, wherein the user input employs data in the form of a numeric passcode, which is stored in another application on a site server, wherein the site server is integrated with an on-site fuel controller to complete at least one action required on the fuel dispenser;
generating a workflow script for an action sequence based on the corresponding instructions to complete a list of required steps for a multi-factor authentication;
receiving data from a web server that describes merchant master data for performing the selected two or more actions of the action sequence on the mobile device;
customizing the workflow script based on the received properties of the mobile device to enable the web server to generate the data for the application stored on the mobile device; and
customizing the workflow script based on user input, in the form of a passcode received from the keypad on the fuel dispenser, wherein a fuel dispenser is integrated with an on-site fuel controller and site server.

14. The method of claim 13, wherein the action sequence comprises a plurality of actions and wherein completing at least one action comprises:
displaying on the mobile device an input screen that identifies a list of available fueling locations;
receiving a user input selecting at least one of the available fueling locations; and
customizing the workflow script for a selected fueling location.

15. The method of claim 13, wherein receiving a user input comprises a valid passcode to facilitate user identification and execution for the selected two or more actions, and wherein the workflow script authorizes the on-site fuel controller to active a fuel dispenser.

16. A network for fuel purchase transactions initiated from a mobile device, the network comprising:
a mobile device communicating with a web server and site server associated with a corresponding on-site fuel pump controller, and with one or more payment networks, wherein the payment networks are associated with user and merchant accounts;
an interface connected to the payment networks and configured to receive information about the desired fuel purchase transaction from a web server, wherein the mobile device generates a fuel purchase request;
wherein the fuel purchase request and payment authorization are validated through a payment network, the payment network being configured to provide a payment token to the site server;
an interface between the site server and an on-site fuel pump controller, wherein the site server is configured to provide instructions to the fuel pump controller to reserve a fuel dispenser and displaying on the fuel dispenser an input screen that requests user input including a customer passcode for authentication; and
wherein the fuel controller is configured to enable the fuel dispenser for a fueling transaction once the customer passcode is validated.

17. The network of claim 16, wherein the fuel pump controller provides completed transaction details to the payment network, the site server, and a point-of-sale system.

18. The network of claim 16, wherein the web server provides rules for fuel purchase transactions to the payment network and the site server, comprising:
user profiles and user-established preferences, data regarding a user financial account associated with each user, security passcode information associated with each user, and an address book associated with fueling merchants, wherein the address book comprises merchant identification information, phone number, geo-location, hours of operation, products, and pricing.
